(19) United States
(12) Patent Application Publication
(10) Pub. No.: US 2004/0212109 A1
(43) Pub. Date: Oct. 28, 2004

(54) Press-molding apparatus, press-molding method and method of producing an optical element

(75) Inventors: Tadayuki Fujimoto, Tokyo (JP); Shinji Hada, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/832,231

(22) Filed: Apr. 27, 2004

(30) Foreign Application Priority Data
Apr. 28, 2003 (JP) 123906/2003
May 26, 2003 (JP) 147426/2003

(51) Int. Cl. B29D 11/00; B29C 33/02

(52) U.S. Cl. 264/1.32; 264/403; 425/407; 425/808

(57) ABSTRACT

In a press-molding apparatus comprising upper and lower dies which are faced with each other and at least one of which is movable as a movable die, and a pair of heating members as upper-die and lower-die heating means (410a and 410b) having heating coils for induction-heating the upper and the lower dies, respectively, the heating member for heating the movable die comprises a first heating coil (410b-1) for heating the movable die in a first position, a second heating coil (410b-2) for heating the movable die in a second position which is apart from the other die than the first position, and a switching unit (420) for selectively supplying the first or the second heating coil with an electric current from a power supply.

This application claims priority to prior Japanese application JP 2003-147426, the disclosure of which is incorporated herein by reference.

### BACKGROUND OF THE INVENTION

This invention relates to a press-molding apparatus and a press-molding method which are used in a production process of an optical element or the like to obtain the optical element or the like by heating and softening a molding material (such as a preform preliminarily formed into an approximate shape) and then press-molding the molding material by the use of a forming die. This invention also relates to a method of producing the optical element.

In order to produce an optical element, a molding material, such as a glass material, in a heated and softened state is press-molded in a forming die which is given a predetermined shape by precision machining and which is heated to a predetermined temperature. As a consequence, a molding surface of the forming die is transferred onto the glass material. Thus, it is possible to obtain the optical element high in surface accuracy and profile accuracy even without post-treatment such as grinding and polishing. In this case, in order to part or release the optical element from the forming die after the press-molding, it is necessary to cool the forming die to an appropriate temperature before parting or releasing. Therefore, in order to mass-produce the optical element by continuously and repeatedly carrying out the press-molding, the forming die must be heated and cooled in a heating cycle within a predetermined temperature range at least between a pressing temperature and a parting temperature.

In this case, if induction heating is used, a coil itself as heating means does not generate heat but an object to be heated (heat generator) is directly heated. Therefore, rapid heating and rapid cooling can be carried out. Thus, the induction heating is advantageous in reduction of a molding cycle time.

In view of the above, it is known that, in precision pressing of the glass optical element, high-frequency induction heating assuring rapid heating and sufficient heating capacity is used as means for heating the forming die.

On the other hand, in order to improve the surface accuracy and the profile accuracy of the optical element to be molded, it is very important to accurately control a molding cycle according to a predetermined heating/cooling schedule in the state where upper and lower dies (upper and lower forming dies) are kept at the same temperature or given a predetermined temperature difference. In order to control the temperatures of the upper and the lower dies to predetermined temperatures, proposal is made of a molding apparatus for heating the upper and the lower molds by high-frequency induction heating while the upper and the lower molds are separated from each other.

As the molding apparatus of the type, Japanese Patent Application Publication (JP-A) No. H05-310434 (Reference 1) discloses a molding apparatus in which a heating coil surrounding upper and lower dies is moved in a direction parallel to a moving direction of the upper and the lower dies to thereby control the temperatures of the upper and the lower dies.

Japanese Patent Application Publication (JP-A) No. H11-171564 (Reference 2) discloses another molding apparatus comprising upper and lower dies one of which is a movable die. When the movable die is located in a separate position apart from a pressing position in order to remove a molded product or to supply a molding material, the movable die is heated in the separate position.

However, the molding apparatus disclosed in Reference 1 requires a large-scale arrangement to be disposed in a molding chamber in order to move the heating coil. In addition, in order to supply the molding material, the lower die must be widely moved down out of the coil. At that time, the temperature of the lower die drops so that a long time is required to heat the lower die.

In the apparatus disclosed in Reference 2, a gap allowing supply of the molding material is left between molding surfaces of the upper and the lower dies separated from each other Therefore, heat is readily removed by a surrounding atmosphere. In case where a positioning member (such as a sleeve) for precisely positioning the upper and the lower dies is protruded on the molding surfaces of the upper and the lower dies, heating efficiency of the positioning member is decreased and thermal deformation is nonuniform. This may result in fitting error of the positioning member.

In particular, in order to increase the productivity, it is proposed to use a molding apparatus which comprises a mother die of an elongated shape and a plurality of forming dies linearly arranged on the mother die to simultaneously press a plurality of materials. In such an apparatus, if heat distribution is not uniform, the mother die is nonuniformly heated so that the mother die tends to be thermally deformed (warped). If the mother die is thermally deformed, upper and lower parts of each individual forming die are impaired in coaxiality in the vertical direction. In this event, the optical element (for example, a lens) molded by the apparatus suffers occurrence of tilt, which causes the deterioration in eccentricity accuracy. In addition, the thickness is nonuniform among the optical elements molded by the individual forming dies.

### SUMMARY OF THE INVENTION

The present inventor extensively studied in order to solve the above-mentioned problems. As a result, it has been found out that, if heating for a next press cycle is started for upper and lower dies separated from each other in order to remove a molded product (optical element) and heating is continuously carried out for the dies closely adjacent to or contacted with each other in order to preheat the dies after removing the molded product, the heating efficiency for a positioning member or the like is improved to prevent deformation of mother dies and to prevent fitting error of the positioning member. In other words, one of the dies as a movable die is continuously heated in a separate position (i.e., a product removing position) and a closely adjacent or a contacted position.

However, a new problem arises. Specifically, it is assumed that heating coils are disposed at both of the product removing position and the closely adjacent position (including the contacted position, the same also applies hereinafter) and heating by both of the heating coils is continuously carried out. In this event, when the movable die is located in the closely adjacent position, a shaft (main shaft) for supporting the movable die is heated by the heating coil in the product removing position to be thermally deformed. This results in decrease in accuracy of the molded product.

Further, if the upper and the lower dies are heated by a single coil, a center portion of the coil, i.e., confronting surfaces of upper and lower mother dies are most easily and quickly heated. As a consequence, the mother dies are warped as illustrated in FIG. 1.

In view of the above, the present inventors further diligently studied. As a result, it has been found out that the above-mentioned problems can be solved by separately arranging an upper-die heating coil and a lower-die heating coil, arranging first and second heating coils for a movable die in a closely adjacent position and a product removal position, respectively, and switching supply of an electric current (energization) to the first and the second heating coils depending upon the position of the movable die. This invention is based on the above-mentioned finding.

It is an object of this invention to provide a press-molding apparatus and a method of producing an optical element, which are capable of preventing thermal deformation of a shaft (main shaft) and stably producing the optical element high in eccentricity accuracy and thickness accuracy in a short production cycle time.

It is another object of this invention to provide a high-precision molding apparatus and a high-precision molding method for producing an optical element, which are capable of achieving desired optical performance without requiring post-treatment, such as polishing, after press-molding.

It is still another object of this invention to provide a press-molding apparatus and a method of producing an optical element, which are capable of simultaneously molding a plurality of optical elements with high production efficiency.

In order to achieve the above-mentioned objects, according to this invention, there is provided a press-molding apparatus comprising upper and lower dies which are faced with each other and at least one of which is movable as a movable die, and a pair of heating members as upper-die and lower-die heating means having heating coils for induction-heating the upper and the lower dies, respectively, wherein the heating member for heating the movable die comprises a first heating coil for heating the movable die in a first position, a second heating coil for heating the movable die in a second position which is apart from the other die than the first position, and switching means for selectively supplying the first or the second heating coil with an electric current from a power supply.

With the above-mentioned structure, it is possible to continuously heat the upper and the lower dies even if the upper and the lower dies are closely adjacent to each other and are separated from each other. Therefore, it is possible to obtain a molded element (optical element) high in surface accuracy and profile accuracy in a short production cycle time. Specifically, irrespective of the timings of supply of a molding material and removal of a molded product, the first or the second heating coil is selectively energized in conformity with movement of the movable die so that a most efficient heating schedule can be selected.

In addition, a shaft (main shaft) is not heated so that the surface accuracy and the profile accuracy of the molded element (optical element) are not degraded.

In the press-molding apparatus in this invention, each of the upper-die and the lower-die heating means has an independent power supply.

With this structure, the upper and the lower dies are independently temperature-controlled. Therefore, it is possible to carry out temperature control independently corresponding to the heat capacity and the predetermined temperature of each of the movable die and a fixed die (each of the upper and the lower dies) and to keep each of the upper and the lower dies at a desired temperature.

Herein, it is preferable that the upper-die heating coil and the lower-die heating coil at the first position are separated by a space corresponding to 0.7 to 2 times the pitch of each heating coil. Preferably, the pitches of the upper-die and the lower-die heating coils are equal to each other and are substantially uniform. If not uniform, the above-mentioned space preferably corresponds to 0.7 to 2 times the average pitch of the heating coils.

If the space between the upper-die and the lower-die heating coils is smaller than 0.7 times the coil pitch, the temperatures of the confronting surfaces of the upper and the lower dies are excessively elevated between the upper-die and the lower-die heating coils so that the upper and the lower dies tend to be warped. On the other hand, if the space is greater than 2 times, the confronting surfaces of the upper and the lower mother dies, in particular, the positioning member, if it is provided, will hardly be heated and will easily be deprived of heat when the upper and the lower mother dies are heated inside the upper-die and the lower-die heating coils. This may result in an increase of a heating time to prolong the cycle time and in defective extension of the molding material.

The apparatus according to the present invention preferably comprises the independent power supplies as mentioned above which provide the oscillation frequencies different from each other. It is advantageous in suppressing the interference of oscillation between the upper and the lower heating means, particularly when they are oscillated in closer positions (i.e., when the movable die in its first position is heated).

A press-molding method of this invention using the above-mentioned molding apparatus comprises energizing the first heating coil when the movable die is in the first position, and energizing the second heating coil when the movable die is in the second position.

In the above-mentioned manner, heating is continuously carried out even if the (movable) die is moved, so that the (movable) die is prevented from being cooled. Thus, production is efficiently carried out in a short cycle time.

In the press-molding method of this invention, it is preferable that the first heating coil for heating the movable die in the first position and the heating coil for heating the other die are energized at different frequencies or energized in a time-division fashion.

If the heating coils closely adjacent to each other are energized at the different frequencies or in the time-division fashion to induction-heat the upper and the lower dies, it is possible to heat the upper and the lower dies to respective predetermined temperatures while suppressing interference of oscillation between the upper and the lower heating means. Further, the upper and the lower dies can be heated in close proximity to each other, this invention also contributes to reduction in molding cycle time.

In the method of this invention, one and the other of the upper and the lower dies faced with each other are a fixed die and a movable die, respectively, and the heating coil for heating the fixed die and the second heating coil for heating the movable die in the second position are simultaneously energized.

Thus, when the heating coils apart from each other are energized even simultaneously, no interference is caused. Therefore, high-frequency induction heating can simultaneously be carried out to increase the heating efficiency. In this manner, the movable die is continuously heated in any position so that the heating efficiency is improved and a temperature balance between the upper and the lower dies is not disrupted.

According to this invention, the above-mentioned method further comprises heating upper and lower dies when the movable die is in the first position, supplying a heated and softened material between the upper and lower dies which are spaced apart so that the movable die is in the second position, press-molding the material to the optical element with the upper and lower dies, and removing the optical element thus molded from between the upper and lower dies when the upper and lower dies are spaced apart so that the movable die is in the second position.

Specifically, the movable die in the first position and the fixed die are heated to predetermined temperatures. Even when the movable die is moved to the second position, the movable die and the fixed dies are heated to the predetermined temperatures and the material is supplied between the movable and the fixed dies.

In the above-mentioned manner, it is possible to suitably carry out temperature control for the upper and the lower dies at least in the die heating step, the material supplying step, and the removing step and to produce the optical element high in surface accuracy and profile accuracy in a short production time.

### BRIEF DESCRIPTION OF THE DRAWING

FIG. 1 is a view showing thermal deformation (warp) of mother dies;

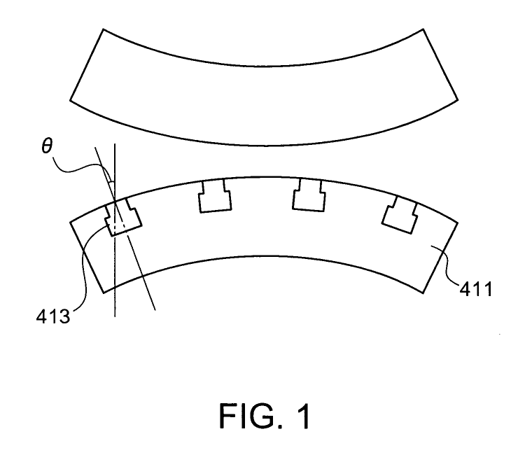

FIG. 2 is a schematic plan view of a press-molding apparatus according to one embodiment of this invention;

FIG. 3 is a schematic plan view of a pressing unit illustrated in FIG. 2;

FIG. 4 shows a side sectional view of the pressing unit illustrated in FIG. 3 together with a power supply circuit;

FIG. 5 is a view similar to FIG. 4 with a time-division control unit added thereto;

FIG. 6 is a view for describing energization of heating coils when heated in a time-division fashion.

FIG. 7 is a schematic plan view of a floating plate and a support arm;

FIG. 8 shows the relationship between upper and lower dies and the heating coils as well as the relationship between the energization of the heating coils and a die temperature; and

FIG. 9 is a view for describing the relationship between a molding eccentricity and an aspheric surface eccentricity.

### DESCRIPTION OF THE PREFERRED EMBODIMENT

Now, an embodiment of this invention will be described with reference to the drawing.

In the following embodiment, this invention is applied to an apparatus for producing a glass optical element. However, this invention is not limited to the embodiment but may be used for production of a resin optical element or production of various other products except the glass optical element and the resin optical element.

[Apparatus for Producing a Glass Optical Element]

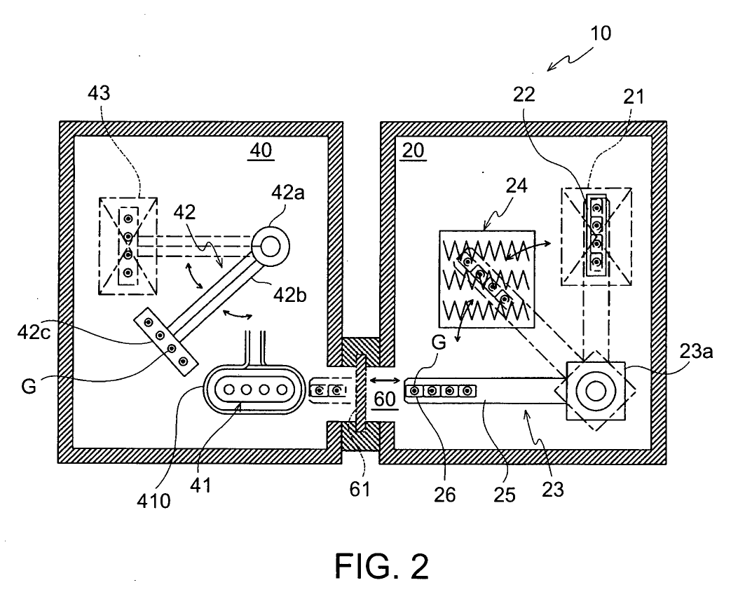

Referring to FIG. 2, an apparatus for producing a glass optical element will be described as an embodiment of the press-molding apparatus according to this invention.

The apparatus illustrated in FIG. 2 is for producing a small-sized collimator lens by pressing a glass preform having a spherical shape. Generally, a plurality of (four in the illustrated example) glass preforms G having a spherical shape are simultaneously supplied into a housing of the apparatus, pressed by forming dies in a heated and softened state, cooled, and delivered out of the housing. By repeating the above-mentioned operations, a number of collimator lenses are continuously produced.

As illustrated in FIG. 2, the apparatus 10 has a heating chamber 20 and a molding chamber 40. The heating chamber 20 and the molding chamber 40 are connected through a passage 60 having an open/close valve 61 to communicate with each other. A combination of the heating chamber 20, the molding chamber 40, and the passage 60 forms a closed space isolated from the outside. The closed space is surrounded by an outer wall which may be formed by a stainless steel or any other suitable material. By the use of a sealing material at connecting portions, airtightness of the closed space is assured. Upon molding the glass optical element, the closed space formed by the heating chamber 20, the molding chamber 20, and the passage 60 is filled with an inactive gas atmosphere. Specifically, by the use of a gas exchange apparatus (not shown), air within the closed space is evacuated and an inactive gas is filled instead. As the inactive gas, use is preferably made of a nitrogen gas or a mixed gas of nitrogen and hydrogen (for example, N₂+0.02 vol % H₂).

The heating chamber 20 is an area where the glass preforms supplied thereto are preliminarily heated prior to pressing. The heating chamber 20 is equipped with a preform supplying unit 22, a preform transporting unit 23, and a preform heating unit 24. Further, a supply preparing chamber 21 for supplying the glass preforms from the outside into the heating chamber 20 is provided.

The supply preparing chamber 21 is provided with four saucers (not shown) on which the four glass preforms are placed by the use of a robot arm (not shown), respectively. The glass preforms on the saucers are sucked by suction pads of the preform supplying unit 22 disposed in the supply preparing chamber 21 and are introduced into the heating chamber 20. In order to inhibit air flow into the heating chamber 20, the supply preparing chamber 21 is closed and filled with an inactive gas atmosphere after the glass preforms are placed on the saucers.

The preform transporting unit 23 receives the glass preforms introduced from the supply preparing chamber 21, transports the glass preforms to a heating area heated by the preform heating unit 24, and further transports the glass preforms in a heated and softened state to the molding chamber 40. The preform transporting unit 23 comprises an arm 25 and four plates 26 fixed to an end of the arm 25, and holds the glass preforms on the plates 26, respectively.

In this embodiment, the arm 25 with the plates 26 is horizontally supported by a driving portion 23a fixed in the heating chamber 20. Driven by the driving portion 23a, the arm 25 is rotated on a horizontal plane at a rotation angle of about 90°. The arm 25 is extendable and retractable in a radial direction from the driving portion 23a as a center. With this structure, the arm 25 transports the glass preforms held on the plates 26 to the molding chamber 40.

The preform transporting unit 23 has an arm opening/closing mechanism (not shown) disposed in the driving portion 23a. The arm opening/closing mechanism serves to open the end of the arm 25 to drop the glass preforms on the plates 26 onto the forming dies.

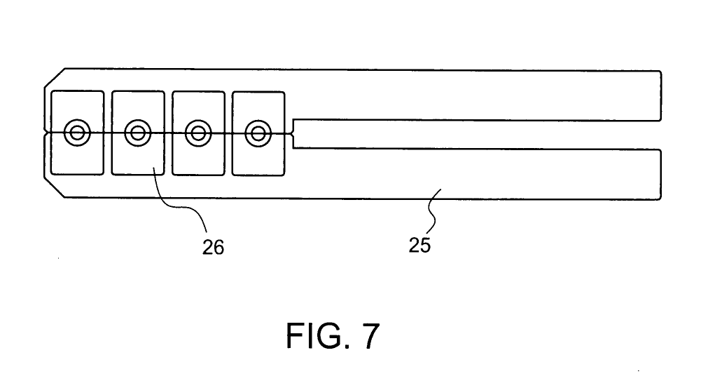

When the glass preform is preheated and transported in a softened state, the glass preform may be contacted with a transporting member, i.e., the preform transporting unit 23. In this event, a defect is caused on a glass surface, resulting in degradation of the profile accuracy of the optical element after molding. In view of the above, the preform transporting unit 23 is preferably provided with a floating member for making the glass preforms be transported in a floated state by the use of a gas. For example, use may be made of a combination of split-type floating plates and a separable arm supporting the floating plates as illustrated in FIG. 7.

In order to automatically remove the optical elements between mother dies separated from each other after molding the optical elements, it is preferable to provide a suction transporting unit having suction pads.

The preform heating unit 24 serves to heat the glass preforms supplied thereto to a predetermined temperature corresponding to a predetermined viscosity. In order to stably heat the glass preforms to the predetermined temperature, it is preferable to use a heater utilizing resistance heating by a resistor element (for example, a Fe—Cr heater). The preform heating unit 24 has a generally 90°-rotated U shape as seen from a lateral side and has upper and lower heater members disposed on upper and lower inner surfaces thereof. As illustrated in FIG. 2, the preform heating unit 24 is placed on a moving track of the glass preforms held on the arm 25.

The arm 25 is placed within the preform heating unit 24 except when the glass preforms are received from the preform supplying unit 22 and when the glass preforms are transported to the molding chamber 40. A heater surface temperature of the preform heating unit 24 may be about 1100° C. and a furnace atmosphere, i.e., an atmosphere between the upper and the lower heater members may be about 700-800° C. In this embodiment, a temperature difference is given between the upper and the lower heater members so as to prevent the arm 25 from being warped in the vertical direction.

On the other hand, the molding chamber 40 is an area where the glass preforms preliminarily heated in the heating chamber 20 are pressed and molded to produce the glass optical elements having a desired shape. The molding chamber 40 is equipped with a pressing unit 41 and a delivering unit 42 for delivering the glass optical elements. Further, a removal preparing chamber 43 is provided in order to deliver the glass optical elements to the outside after the glass optical elements are press-molded.

The pressing unit 41 receives the four glass preforms transported by the preform transporting unit 23 from the heating chamber 20 and presses the glass preforms to obtain the glass optical elements having a desired shape. The pressing unit 41 has upper and lower dies provided with molding surfaces and simultaneously presses the four glass preforms supplied therebetween by the molding surfaces. The four glass preforms on the arm 25 of the preform transporting unit 23 are dropped onto the lower die by opening the end of the arm 25. Immediately after the arm 25 is retreated from a position between the upper and the lower dies, the lower die moves up towards the upper die. Consequently, the glass preforms clamped between the upper and the lower dies are pressed. Each of the upper and the lower dies comprises the mother die and the forming dies supported on the mother die.

The forming dies are surrounded by a high-frequency induction heating coil 410 for heating the forming dies. Prior to pressing the glass preforms, the forming dies are heated by the induction heating coil 410 and kept at a predetermined temperature. The temperature of the forming dies upon pressing may be substantially equal to or slightly lower than the temperature of the glass preforms preliminarily heated. Preferably, the temperature of the forming dies is lower than that of the glass preforms so that the molding cycle time is shortened and deterioration of the forming dies is suppressed. As will later be described in detail, heating by the induction heating coil 410 is carried out independently for the upper and the lower dies.

The delivering unit 42 serves to deliver the glass optical elements pressed by the pressing unit 41 to the removal preparing chamber 43. The delivering unit 42 has a driving portion 42a, an arm 42b rotatably supported on the driving portion 42a, and four suction pads 42c fixed to an end of the arm 42b. The suction pads 42c sucks the four glass optical elements on the forming dies of the lower die by vacuum sucking so as to enable delivery of the glass optical elements by the delivering unit 42. The glass optical elements thus sucked are delivered by the rotation of the arm 42b to a position below the removal preparing chamber 43 and are placed on an elevating member (not shown) equipped at that position. After the arm 42b is retreated, the elevating member is moved upward and the glass optical elements are delivered to the removal preparing chamber 43.

In this embodiment, a lens mounting surface of the elevating member closes an opening of the removal preparing chamber 43, which communicates with the molding chamber 40, to thereby inhibit gas exchange between the removal preparing chamber 43 and the molding chamber 40. After opening an upper part of the removal preparing chamber 43, the glass optical elements in the removal preparing chamber 43 are successively delivered to the outside by the use of a delivering member such as a robot arm. After the glass optical elements are delivered, the removal preparing chamber 43 is closed and filled with an inactive gas.

[Pressing Unit]

Next, the pressing unit 41 will be described in detail.

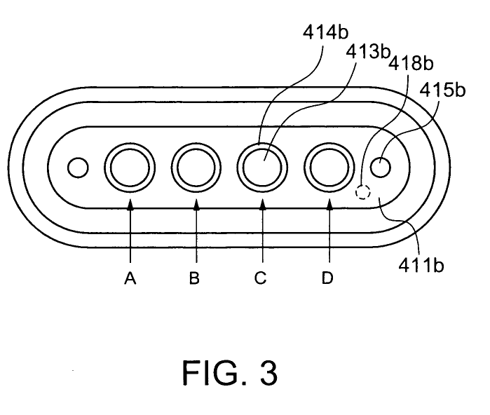

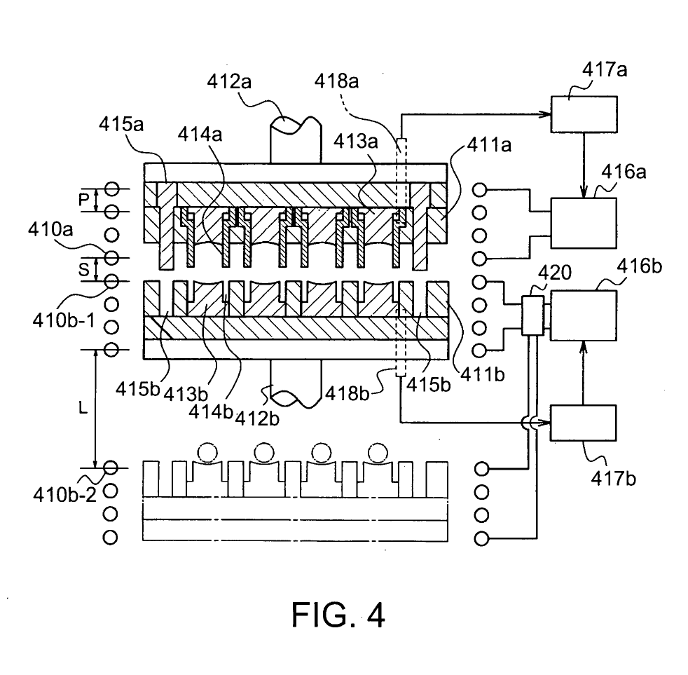

Referring to FIGS. 3 and 4, the pressing unit 41 comprises the upper and the lower dies, each of which has a mother die and forming dies. The upper and lower mother dies 411a and 411b have an elongated shape and are attached to upper and lower main shafts 412a and 412b as fixed and movable main shafts, respectively. The upper mother die 411a and the lower mother die 411b are provided with a plurality of upper forming dies 413a and a plurality of lower forming dies 413b, respectively. In the illustrated example, the number of each of the upper and the lower mother dies 411a and 411b is equal to four but may be any desired number between two and ten.

The upper mother die 411a is attached to the upper main shaft 412a, which is fixed to an apparatus body. The lower mother die 411b is attached to the lower main shaft 412b driven by a servo motor (not shown). With the above-mentioned structure, the lower mother die 411b can be moved between a first position where the upper and the lower forming dies 413a and 413b are closely adjacent to each other and a second position where the upper and the lower forming dies 413a and 413b are separated from each other by a predetermined distance and can be stopped at the first and the second positions in various steps (a die heating step, a material supplying step, a pressing step, a parting step, and a removing step) of a molding process.

The upper and the lower mother dies 411a and 411b are contacted and separated in response to a driving signal sent from a molding control portion (not shown) to the servo motor in accordance with a predetermined molding cycle.

In the press-molding apparatus in this embodiment, only the lower mother die is movable. Alternatively, only the upper die or both of the upper and the lower dies may be movable.

At the position where the upper mother die 411a is fixed, an upper-die induction-heating coil (upper-die heating coil) 410a surrounding the upper mother die 411a is disposed. For the lower mother die 411b, a first induction-heating coil (first lower-die heating coil) 410b-1 and a second induction-heating coil (second lower-die heating coil) 410b-2 (which may collectively be referred to as lower-die heating coils 410b) are disposed in the vicinity of the first and the second positions so as to surround the lower mother die 411b when the lower mother die 411b is stopped at the first and the second positions, respectively. The first and the second lower-die heating coils 410b-1 and 401b-2 are connected to a switching unit 420 for selectively heating the first or the second lower-die heating coil 410b-1 or 410b-2.

The distance S between the upper-die heating coil 410a and the first lower-die heating coil 410b-1 in the vertical direction preferably corresponds to 0.7 to 2 times the average coil pitch P of the upper-die and the lower-die heating coils, more preferably, 0.8 to 1.5 times. If the distance S between the upper-die and the first lower-die heating coils 410a and 410b-1 in the vertical direction is smaller than the above-mentioned range, the upper and the lower dies tend to warp due to temperature elevation at confronting surfaces of the upper and the lower dies. If the distance S is greater than the above-mentioned range, the upper and the lower dies are not closely adjacent to each other when the lower die is heated in the first position. Accordingly, the heating efficiency at the confronting surfaces of the upper and the lower dies is decreased.

In this embodiment, in order to arrange the upper-die and the first lower-die heating coils 410a and 410b-1 in close proximity to each other, the distance between the coils is substantially equal to the average coil pitch.

As will later be described in detail, the upper-die and the lower-die heating coils 410a and 410b are independently connected to power supplies and temperature control portions, respectively, whose outputs are independently controllable.

Therefore, even if the upper and the lower mother dies 411a and 411b are considerably different in heat capacity, it is possible to controllably heat the upper and the lower mother dies 411a and 411b to the same temperature and, on the contrary, to give a desired temperature difference between the upper and the lower mother dies 411a and 411b. The numbers of turns and the ranges of location of the upper-die heating coil 410a and the first and the second lower-die heating coils 410b-1 and 410b-2 are determined taking into account the heat capacities of the upper and the lower mother dies 411a and 411b.

When the upper and the lower mother dies 411a and 411b are independently heated by the power supplies and the heating coils, it is possible to prevent the confronting surfaces of the upper and the lower mother dies from being heated to a higher temperature, as compared with the case where the upper and the lower mother dies 411a and 411b are heated by a single coil. As a consequence, the mother dies are prevented from being warped. Thus, such independent control is especially advantageous in a high-precision lens in which deterioration in eccentricity accuracy (tilt of the axis of each of the upper and the lower dies) resulting from the warp causes a serious problem. Further, prevention of the warp enables accurate positioning of the upper and the lower mother dies and is therefore effective in improvement of the eccentricity accuracy (decenter, i.e., displacement of the axes of the upper and the lower dies).

As the material of the upper and the lower mother dies 411a and 411b, use is made of a heat generating material which generates heat by induction heating and which has heat resistance. For example, the heat generating material may be a tungsten alloy or a nickel alloy. As the upper and the lower forming dies 413a and 413b, a ceramic material, such as silicon carbide or silicon nitride, or cemented carbide may be used.

It is noted here that the heat generating material for use as the upper and the lower mother dies 411a and 411b preferably has a coefficient of thermal expansion approximate to that of the material of the upper and the lower forming dies 413a and 413b. For example, in case where the forming dies are made of a ceramic material, a tungsten alloy is preferably used as the heat generating material.

On the molding surface of each of the upper and the lower forming dies 413a and 413b, a releasing film may be formed. As the releasing film, a film of precious metal (such as Pt, Ir, Au) or a film containing carbon as a main component may be used. The carbon film is advantageous because it is inexpensive and excellent in releasing effect.

The upper and the lower mother dies 411a and 411b are completely separated when the molding material is supplied and when the molded product is removed. Therefore, when the upper and the lower mother dies 411a and 411b are moved towards each other upon pressing, the upper and the lower mother dies 411a and 411b must be precisely positioned. To this end, guide pins 415a and guide holes 415b are provided in order to position the upper and the lower mother dies 411a and 411b with respect to each other. The guide pins 415a and the guide holes 415b may collectively be called a guide member. In this embodiment, the upper mother die 411a is provided with the guide pins 415a while the lower mother die 411b is provided with the guide holes 415b.

Further, each of the four upper forming dies 413a is provided with a sleeve 414a formed at an outer periphery thereof. On the other hand, each of the four lower forming dies 413b is provided with a sleeve hole 414b to be fitted to the sleeve 414a with a narrow clearance. The sleeves 414a and the sleeve holes 414b may collectively be called a sleeve member. With this structure, when the upper and the lower mother dies 411a and 411b approach each other, the sleeve 414a of the upper forming die 413a and the sleeve hole 414b of the lower forming die 413b slide along each other and are fitted to each other with the narrow clearance. Thus, the upper and the lower forming dies 413a and 413b are further precisely positioned with respect to each other. As a result, the eccentricity accuracy (decenter and tilt) can be maintained within a predetermined range.

Preferably, the clearance between the guide pin 415a and the guide hole 415b for positioning the upper and the lower mother dies 411a and 411b is 10-40 μm. On the other hand, the clearance between the sleeve 414a of the upper forming die 413a and the sleeve hole 414b of the lower forming die 413b is preferably 1-10 μm. In either case, if the clearance is smaller than the above-mentioned range, sliding can not smoothly be carried out. If the clearance is greater than the above-mentioned range, play is caused and the positioning accuracy is decreased.

Without being restricted to the above, the upper and the lower dies (the upper and the lower mother dies and the upper and the lower forming dies) may be positioned in a different manner. For example, a protruding member may be formed on the lower mother die (lower die). Also, only one of the guide member (the guide pins and the guide holes) and the sleeve member (the sleeves and the sleeve holes) may be formed.

As illustrated in FIG. 4, the heating coils 410a and 410b in this embodiment are respectively connected to independent power supplies (an upper-die power supply 416a and a lower-die power supply 416b). The upper-die and the lower-die power supplies 416a and 416b are respectively connected to independent temperature control portions (an upper-die temperature control portion 417a and a lower-die temperature control portion 417b). The upper-die power supply 416a independently supplies an electric current to the upper-die heating coil 410a while the lower-die power supply 416b independently supplies an electric current to the lower-die heating coil 410b.

In this embodiment, a combination of the upper-die heating coil 410a, the upper-die power supply 416a, and the upper-die temperature control portion 417a forms an upper-die heating arrangement while a combination of the lower-die heating coil 410b (410b-1 and 410b-2), the lower-die power supply 416b, the lower-die temperature control portion 417b, and the switching unit 420 forms a lower-die heating arrangement.

The upper-die heating coil 410a and the first lower-die heating coil 410b-1 have oscillation frequencies different from each other. Herein, the ratio of the oscillation frequencies of the upper-die heating coil 410a and the first lower-die heating coil 410b-1 is preferably 1:1.5 or more, more preferably, 1:1.5 to 1:7.

If the oscillation frequencies of the upper-die and the lower-die heating arrangements are significantly different, heating environments, such as the penetration depths of induction heating and energy transfer efficiencies from the coils, are different so that press molding conditions are different between the upper and the lower dies. The ratio of the oscillation frequencies within the above-mentioned range is advantageous because the heating environments for the upper and the lower dies are substantially same. Further, within the above-mentioned range, the degrees of oxidation of the mother dies as a result of heating are substantially equivalent. Therefore, heat radiation conditions under the influence of surface conditions are substantially equivalent also. More preferably, the range is 1:1.5 to 1:3, especially, 1:1.5 to 1:2.

Either of the oscillation frequencies of the upper-die heating coil 410a and the first lower-die heating coil 410b-1 may be higher. Preferably, the coil corresponding to one of the upper and the lower dies which is smaller in heat capacity has a higher frequency.

Preferably, the oscillation frequency of each of the upper-die and the lower-die power supplies 416a and 416b falls within a range of 15-100 kHz. The reason is as follows. If the oscillation frequency of the power supply exceeds 100 kHz, the penetration depth of induction heating is small (shallow) so that only a surface portion of the mother die is heated to a high temperature. In this event, radiation heat loss towards the surroundings is increased and the heating efficiency of the forming dies arranged on the mother die is decreased. Such a high frequency is unfavorable in view of the cost also.

The oscillation frequency lower than 15 kHz falls within an audio frequency band and results in production of an unpleasant sound or a noise. For example, one and the other of the oscillation frequencies of the upper-die and the lower-die power supplies 416a and 416b are 15-50 kHz and 20-50 kHz.

The frequency of the second lower-die heating coil 410b-2 may appropriately be selected. However, if the first and the second lower-die heating coils 410b-1 and 410b-2 are operated by the single power supply as in this embodiment, the first and the second lower-die heating coils 410b-1 and 410b-2 are preferably oscillated at a single common frequency. In this case, the oscillation frequency of the second lower-die heating coil 410b-2 preferably falls within the range of 15-100 kHz, for example, 20-50 kHz. Preferably, a circuit of each of the upper-die and the lower-die heating arrangements is provided with noise protection (such as a shield or a noise filter).

When the lower mother die 411b is located in the first position closely adjacent to the upper mother die 411a, the lower-die heating arrangement supplies an electric current to the first lower-die heating coil 410b-1 via the switching unit 420. When the lower mother die 411b is located in the second position apart from the upper mother die 411a, the lower-die heating arrangement supplies an electric current to the second lower-die heating coil 410b-2. Thus, the lower main shaft 412b is prevented from being damaged or expanded under the heat of the second lower-die heating coil 410b-2 and power consumption is efficient. Upon switching, it is preferable to keep a predetermined time interval (for example, 0.5 to 2 seconds) after the electric current to the first lower-die heating coil 410b-1 is stopped and before the electric current is supplied to the second lower-die heating coil 410b-2. In this manner, it is possible to stop heating by the second lower-die heating coil 410b-2 during the movement of the lower mother die 411b.

The distance between the first and the second lower-die heating coils 410b-1 and 410b-2 is determined by the traveling distance of the lower die in the vertical direction. If the above-mentioned distance is excessively large, the traveling distance of the lower die is increased so that the molding surface of the lower die is cooled by an atmosphere during the movement. On the other hand, if the distance is excessively small, the supply of the preforms and the delivery of the optical elements after molded are not smoothly carried out. Taking the above into account, the distance L between the first lower-die heating coil 410b-1 (lower end) and the second lower-die heating coil 410b-2 (upper end) is, for example, between 20 and 80 mm.

Temperature control for the upper and the lower forming dies 413a and 413b is carried out in the following manner. The mother dies 411a and 411b are provided with an upper-die temperature sensor (thermocouple) 418a and a lower-die temperature sensor (thermocouple) 418b, respectively. Outputs of the upper-die and the lower-die temperature sensors 418a and 418b are supplied to upper-die and lower-die temperature control portions 417a and 417b, respectively. In order that the predetermined temperatures are reached, for example, PID (Proportion, Integration, Derivation) control is carried out. Even if the upper and the lower mother molds 411a and 411b are considerably different in heat capacity, target temperatures can be reached by independently controlling the temperatures of the upper and the lower forming dies 413a and 413b in correspondence to the heat capacities of the mother dies and power supply capacities. Further, by adjusting the outputs of the upper-die and the lower-die power supplies 416a and 416b in conformity with the heat capacity ratio between the upper and the lower mother dies 411a and 411b, the upper and the lower forming dies 413a and 413b can reach the target temperatures in heating times substantially equal to each other.

As described above, the upper and the lower mother dies 411a and 411b are contacted and separated in response to the driving signal sent from the molding control portion (not shown) to the servo motor in accordance with the predetermined molding cycle. Specifically, when the glass preforms are supplied, the lower mother die 411b is stopped at the second position apart from the upper mother die 411a. In order to keep the upper and the lower dies to the predetermined temperatures, the lower mother die 411b can be stopped at the first position where the upper and the lower mother dies 411a and 411b are closely adjacent to each other. Upon supplying the glass preforms, the glass preforms are supplied by the transporting unit 23 through a space between the upper and the lower mother dies 411a and 411b to upper parts of the lower forming dies 413b. When the glass preforms are press-molded, the lower mother die 411b is brought into press contact (tight contact) with the upper mother die 411a so as to apply a predetermined load.

In order to remove the optical elements after pressed, the lower mother die 411b is moved downward and stopped at the second position. Then, the optical elements after molded are removed by the delivering unit 42 from the space between the upper and the lower mother dies 411a and 411b. Herein, the positions of the lower mother die when the glass preforms are supplied and when the optical elements after pressed are removed are the same position (the second position). However, these positions need not be the same as far as the lower mother die is sufficiently heated by the second lower-die heating coil surrounding the lower mother die.

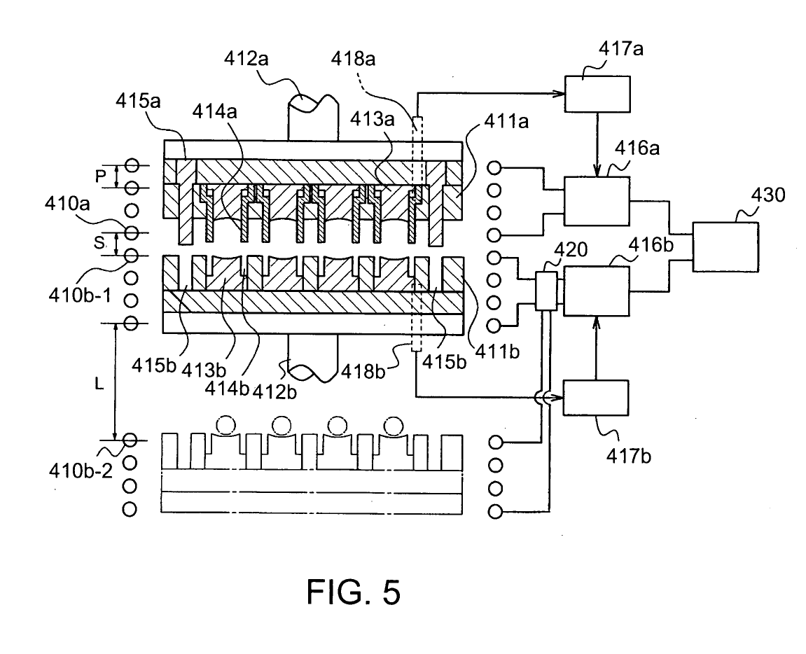

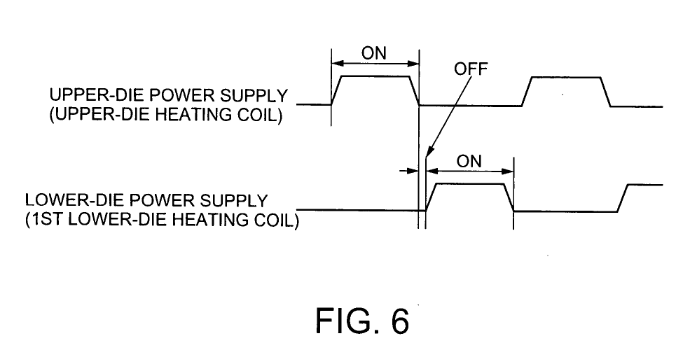

Referring to FIG. 5, the upper-die heating coil 410a and the first lower-die heating coil 410b-1 may be energized in a time-division fashion. In this case, a time-division control portion 430 controls energizing times of the upper-die and the lower-die power supplies. The time-division control portion 430 produces gate signals for alternately energizing the upper-die heating coil 410a and the first lower-die heating coil 410b-1. Examples of the gate signals are illustrated in FIG. 6. The energizing time and the deenergizing time for each of these heating coils is about 0.75 second and about 0.1 second, respectively.

[Method of Producing a Glass Optical Element]

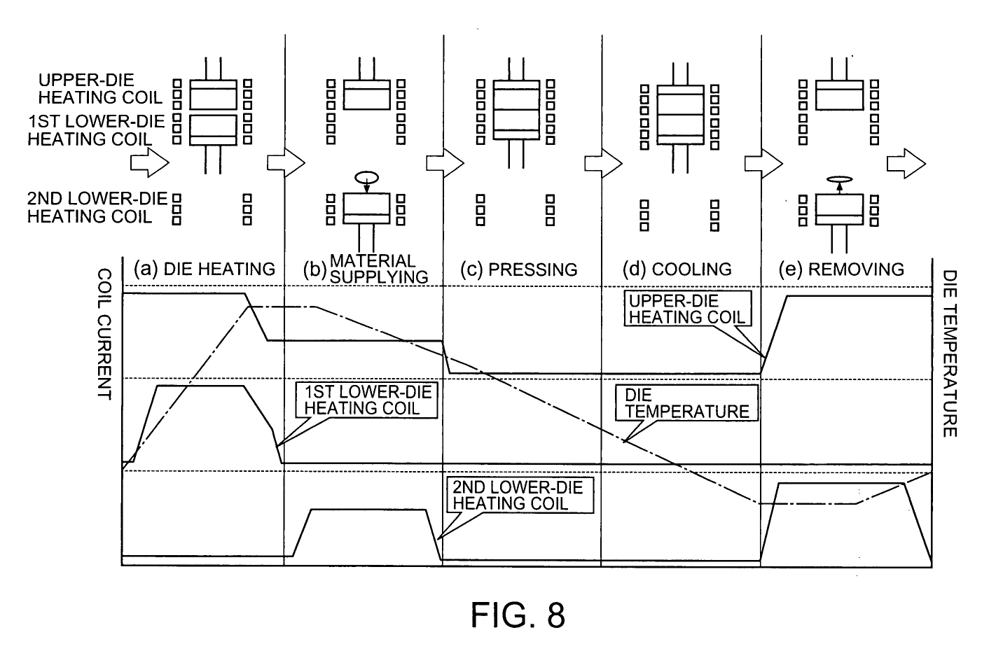

Referring to FIG. 8, description will be made of a method of producing a glass optical element according to one embodiment of this invention by the use of the apparatus having the above-mentioned structure.

(a) Die Heating Step

The upper and the lower forming dies after completion of a previous molding cycle are cooled to a temperature around Tg or lower than Tg. Therefore, it is necessary to heat the upper and the lower forming dies to a temperature suitable for press molding. To this end, the lower mother die 411b is moved to the first position closely adjacent to the upper mother die 411a and stopped. At this time, the lower mother die 411b is surrounded by the first lower-die heating coil 410b-1. The first lower-die heating coil 410b-1 mentioned above and the upper-die heating coil 410a surrounding the upper mother die 411a are supplied with electric currents so that the upper and the lower mother dies 411a and 411b generate heat. By heat conduction, the upper and the lower forming dies are heated to the predetermined temperatures (see (a) in FIG. 8). At this time, it is important to minimize variation in temperature among the forming dies.

The predetermined temperatures of the upper and the lower forming dies are generally equal to each other. Alternatively, depending upon the shape and the diameter of the lens to be molded, a temperature difference may be given between the upper and the lower forming dies.

The heat capacities of the upper and the lower mother dies are often different so that the heating efficiencies are different. Taking this into consideration also, the number of turns of the high-frequency coils and the output ranges are determined.

In the molding apparatus in this embodiment, the upper-die heating coil 410a and the first lower-die heating coils 410b-1 are closely adjacent to each other in order to heat the upper and the lower mother dies in close proximity to each other. As described above, the distance between the upper-die heating coil 410a and the first lower-die heating coil 410b-1 preferably corresponds to 0.7 to 2 times the coil pitch. If the upper-die heating coil 410a and the first lower-die heating coil 410b-1 are apart from each other by a large distance as compared with the coil pitch, the protruding members such as the sleeves 414a protruding above the confronting surfaces of the upper and the lower mother dies 411a and 411b are hardly heated and are easily deprived of heat when the upper and the lower mother dies 411a and 411b are heated. This results in an increase in heating time to prolong the cycle time, in fitting error when the sleeves 414a are fitted to the sleeve holes 414b to restrict the position, and in defective extension of the molding material.

In this embodiment, the protruding members such as the sleeves 414a and the guide pins 415a formed on the upper mother die 411a may be contacted with or fitted to the sleeve holes 414b and the guide holes 415b of the lower mother die 411b during the die heating step. If the die heating is carried out while the protruding members such as the sleeves 414a and the guide pins 415a are contacted with or fitted to the sleeve holes 414b and the guide hole 415b, an exposed portion of the protruding members is reduced so that cooling by the atmosphere is suppressed and the exposed portion is sufficiently heated.

However, contacting or fitting is not essential but it is sufficient that the upper and the lower confronting surfaces and the protruding members form a space capable of preventing convection of an atmospheric gas.

The predetermined temperatures of the upper and the lower mother dies 411a and 411b may be equal to each other or may be given a temperature difference. For example, depending upon the shape and the diameter of the optical element to be molded, the temperature of the lower mother die 411b may be higher or lower than that of the upper mother die 411a. The temperatures of the upper and the lower mother dies 411a and 411b may correspond to 10⁸ to 10¹² poises as the viscosity of the glass preform. In case where the temperature difference is given between the upper and the lower mother dies 411a and 411b, the temperature difference preferably falls within a range of 2-15° C.

The temperature control of the upper and the lower mother dies 411a and 411b is carried out in the following manner. The outputs of the upper-die and the lower-die temperature sensors (thermocouples) 418a and 418b on the upper and the lower mother dies 411a and 411b are supplied to the upper-die and the lower-die temperature control portions 417a and 417b, respectively. In order that the predetermined temperatures are reached, for example, PID control is carried out.

The outputs of the heating coils may be reduced by decreasing the electric currents supplied thereto when approaching the target temperatures.

As described above, the upper-die heating coil 410a and the first lower-die heating coil 410b-1 are different in oscillation frequency. In this manner, even if the coils are simultaneously oscillated in close proximity to each other, it is possible to prevent unstable heating or occurrence of an unpleasant noise resulting from mutual interference. In case where the upper-die heating coil 410a and the first lower-die heating coil 410b-1 are oscillated in a time-division fashion, the mutual interference can further reliably be reduced.

The die heating step may be carried out in a desired time period depending upon the size (heat capacity) of the mother dies and the capacity of the power supplies. For example, the die heating step is carried out for about 20-40 minutes.

Thus, the upper and the lower dies can independently and quickly be temperature-controlled.

(b) Material Supplying Step

The lower mother die 411b heated in the die heating step is moved down to the second position to separate the upper and the lower forming dies. The preforms (glass materials) are delivered and supplied through the space between the upper and the lower dies and placed on the lower forming dies.

When heating during the die heating step is finished, the switching unit 420 stops supply of the electric current to the first lower-die heating coil 410b-1. When the lower mother die 411b is moved to the second position and stopped, the switching unit 420 supplies the electric current to the second lower-die heating coil 410b-2 located at the second position to thereby heat the second lower-die heating coil 410b-2. Therefore, the lower mother die 411b is continuously heated even when the lower mother die 411b is stopped at the second position in a die-opened state so as to supply the molding material. Thus, the time required to reach the desired temperature is minimized.

Since the upper and the lower dies approach the target temperatures in the die heating step, heating output at the material supplying step can be lower than that during the die heating step (see (b) in FIG. 8). At this time, the temperature distribution in the mother die is reduced so as to achieve uniform heating among the forming dies.

The glass material thus supplied may be a glass material preliminarily formed into a predetermined shape with an appropriate weight and softened to the viscosity suitable for molding. Alternatively, the glass material at a temperature lower than the temperature suitable for molding may be supplied between the upper and the lower dies and further heated on the dies. In case where the glass material is preliminarily heated to a temperature higher than the predetermined temperature of the dies and is supplied in a softened state (in case of so-called non-isothermal press), the die temperature must precisely be controlled. Therefore, this invention is advantageously applied. In this event, the molding cycle time can be shortened so as to improve the production efficiency.

At that time, the temperature of the glass material corresponds to the viscosity lower than 10⁹ poises, preferably 10⁶-10⁸ poises.

When the glass material in a softened state is transported and placed on the lower die, the glass material may be contacted with a transporting member to cause a surface defect. This affects the surface profile of the optical element to be molded. In view of the above, it is preferable to use an arrangement for making the glass material being softened be transported in a floated state by the use of a gas and dropping the glass material onto the lower die.

The material supplying step is preferably as short as possible. For example, the material supplying step is carried out for about 1 to 5 seconds.

(c) Pressing Step

In the state where the upper and the lower dies and the glass material fall within the respective predetermined temperature ranges and the glass material is heated and softened, the lower mother die 411b is moved upward to the first position to bring the upper and the lower dies into press contact (tight contact) with each other and press the upper and the lower dies so that the molding surfaces of the upper and the lower dies are transferred. As a consequence, the glass optical element having a predetermined surface profile is molded. The lower die is moved upward by actuating driving means (for example, a servo motor). In case where the glass material in a heated and softened state is supplied, pressing is carried out immediately after supplying.

The up stroke of the lower die for pressing is preliminarily determined with reference to the thickness of the optical element to be molded, taking into account heat shrinkage of the glass in a subsequent cooling step. A pressing schedule may appropriately be determined depending upon the shape and the size of the optical element to be molded. Furthermore, a plurality of times of pressing may be carried out, for example, by carrying out a first pressing operation, then reducing or releasing the load, and thereafter carrying out a second pressing operation.

In view of reduction in production cycle time, it is preferable to stop supply of the electric currents to the heating coils 410a and 410b once the pressing step is started (see (c) in FIG. 8). In this manner, temperature rise of the upper and the lower mother dies is stopped and the upper and the lower mother dies proceed to cooling.

The pressing step is preferably as short as possible. For example, the pressing step is carried out for about 1 to 10 seconds.

(d) Cooling/Parting Step

In the state where the pressure is maintained or decreased, the glass optical elements thus molded are kept in tight contact with the forming dies. After cooled down to a temperature corresponding to 10¹² poises as the viscosity of the glass, the glass optical elements are separated from the dies. The parting temperature is preferably not higher than a temperature corresponding to 10^{12.5} poises, more preferably within a temperature range corresponding to 10^{12.5} to 10^{13.5} poises in view of reduction of a production cycle time.

In this case also, the lower mother die 411b is located in the first position. However, the first lower-die heating coil 410b-1 is not supplied with an electric current, i.e., is not heated. The upper mother die 411a is not heated also (see (d) in FIG. 8).

On the other hand, depending upon the composition of the glass material (a phosphate glass, a borate glass, or the like) or depending upon the shape of the optical element (a concave meniscus lens or the like), the optical element may be susceptible to occurrence of cracks. In this case, it is possible to drop the temperature while the heating coils 410a and 410b-1 are continuously supplied with the electric currents after starting the pressing step. In this event, the effect of the heating arrangements of this invention is remarkable because temperature control is carried out as desired while the upper and the lower mother dies are kept in contact with each other.

The time required for the cooling step is appropriately determined depending upon the shape, the thickness, the diameter, and the desired surface accuracy of the optical element. For example, the cooling step is carried out for about 25 to 40 seconds.

(e) Removing Step

By the use of a removing arm having a sucking member or the like, the glass optical elements having been molded are automatically removed from the upper and the lower dies separated from each other. At this time, the lower mother die 411b is moved down to the second position. Again, the upper-die heating coil 410a is supplied with the electric current from the upper-die power supply 416a while the second lower-die heating coil 410b-2 is supplied with the electric current from the lower-die power supply 416b through the switching unit 420. As a consequence, the upper and the lower mother dies are heated by these heating coils. Thus, heating of the upper and the lower mother dies is started for a next molding cycle (see (e) in FIG. 8).

The removing step is carried out, for example, about 1 to 6 seconds.

By repeating the above-mentioned steps, continuous press molding is carried out. For example, the time required for the molding cycle is preferably about 45 to 95 seconds.

In the foregoing embodiment, the upper die is fixed while the lower die is a movable die. Alternatively, the upper die may be a movable die while the lower die may be fixed. Further alternatively, both of the upper and the lower dies may be movable dies.

For example, the optical element produced by the method of this invention may be a lens. Without being restricted in shape, the lens may be a bi-convex lens, a bi-meniscus lens, a convex meniscus lens, and so on. In particular, even in a medium-aperture lens having a lens outer diameter of 15-25 mm, the thickness accuracy and the eccentricity accuracy can be excellently maintained. For example, the thickness accuracy is within ±0.03 mm. As the eccentricity accuracy, this invention is advantageously applicable to production of the optical element having a tilt of 2 arcmin or less and a decenter of 10 μm or less.

Next, description will be made of the result of a specific example in which the glass optical element was produced by the use of the molding apparatus and the method of this invention.

### EXAMPLE 1

By the use of a press molding apparatus illustrated in FIGS. 2 through 4 and through the steps illustrated in (a) to (e) in FIG. 8, a flat spherical preform of a barium borosilicate glass (having a transition point of 515° C. and a sagging point of 545° C.) was pressed to obtain a bi-convex lens (having one surface as a spherical surface and the other surface as an aspheric surface, the radius of curvature of the spherical surface being 50 mm, the paraxial radius of curvature of the aspheric surface being 28.65 mm, the center thickness being 2 mm) having an outer diameter of 18 mm.

The above-mentioned lens has a flange-like flat portion at its periphery. By comparing the maximum thickness and the minimum thickness at that portion, the tilt of the axis of each of the upper and the lower forming dies, i.e., the molding tilt can be measured.

Four sets of the forming dies for the bi-convex lenses and the sleeve were attached to the upper and the lower mother dies. The upper and the lower mother dies had a volume ratio (=heat capacity ratio) of 10:7. The upper-die power supply of the apparatus had a maximum output of 30 kW and a frequency of 18 kHz while the lower-die power supply had a maximum output of 30 kW and a frequency of 35 kHz.

By the above-mentioned heating step (a), the upper and the lower mother dies were heated. Simultaneously, in a heating furnace (not shown) at a different place, the glass preforms were heated and softened in a floated state. Specifically, the glass preforms were floated up by a gas stream blown up from the below on split-type floating plates (made of glassy carbon) on an openable/closable support arm illustrated in FIG. 7. By splitting the floating plates, the glass preforms were dropped and supplied onto the lower forming dies. At this time, preheating temperatures of the preforms and the mother dies were equal to 625° C. (corresponding to 10⁷ poises as the viscosity of the glass) and 580° C. (corresponding to 10^{8.5} poises as the viscosity of the glass), respectively. Immediately after dropping and supplying the preforms, the support arm was retreated and the lower mother die was moved upward. Then, pressing was started at a pressure of 150 kg/cm².

After starting the pressing, pressing was continued without heating until the upper and the lower mother dies are brought into contact with each other. Then, a nitrogen gas was blown to side surfaces of the mother dies. Simultaneously, the nitrogen gas was made to flow into the mother dies to start cooling.

Thereafter, cooling was continued until the temperature not higher than the transition point was reached while the forming dies and the glass optical elements were kept in contact with each other. Then, the lower mother die was moved down and the lenses as press molded products were removed by a removing unit having suction pads while heating by the second lower-die heating coil was started. Immediately after removal, heating of the upper and the lower mother dies was started and a next pressing cycle was continuously carried out. In this apparatus, the heating rates of the upper and the lower mother dies were substantially equal to each other and the molding cycle time was 60 seconds. The performances of the four lenses thus molded are shown in Table 1.

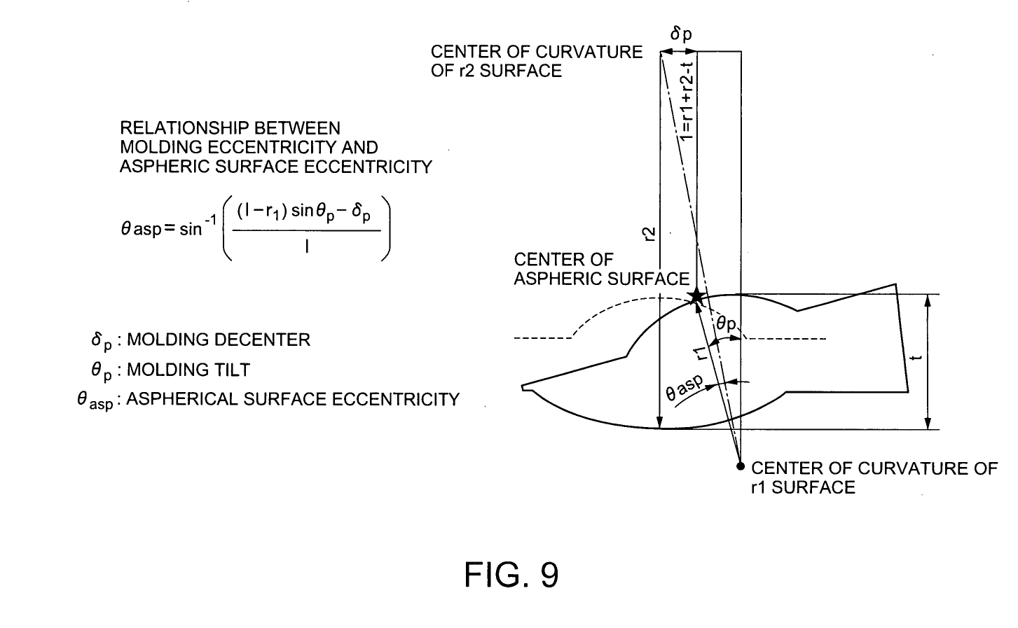

Herein, the molding tilt is an eccentricity of the lens resulting from the tilt of the axis of each of the upper and the lower forming dies. The molding decenter is an eccentricity of the lens resulting from the shifts of the upper and the lower forming dies in the horizontal direction. The eccentricity of the aspheric surface was measured by a known aspheric surface analyzer. The molding tilt was calculated from the difference between the minimum thickness and the maximum thickness of the flat portion at the periphery of the molded lens and the press diameter of the lens. The relationship between the aspheric surface eccentricity, the molding tilt, and the molding decenter is illustrated in FIG. 9. From the relationship, the molding decenter was calculated.

All the four lenses satisfied the specification including the surface accuracy.

TABLE 1

| | aspheric | | | | |
|---|---|---|---|---|---|
| | surface | molding | molding | center | |
| | eccentricity | tilt | decenter | thickness | |
| specification | | <2′ 30″ | <0.015 mm | 2 ± 0.03 | mm |
| position A | 1′ 00″ | 1′ 20″ | 0.005 mm | 2.005 | mm |
| position B | 1′ 00″ | 1′ 00″ | 0.008 mm | 2.003 | mm |
| position C | 1′ 00″ | 1′ 00″ | 0.008 mm | 1.992 | mm |
| position D | 1′ 20″ | 1′ 10″ | 0.012 mm | 2.010 | mm |

As described above, when a plurality of (four in this example) forming dies were arranged on each of the mother dies of an elongated shape and the four preforms were simultaneously pressed, an excellent result was obtained. Thus, even if the mother dies are increased in size in order to simultaneously mold a number of lenses at a single pressing operation, heating of the mother dies, in particular, heating of the movable mother die is efficiently carried out by a plurality of heating coils and the switching unit. Therefore, it is possible to mold the optical elements with high eccentricity accuracy (tilt, decenter).

Since the upper and the lower heating arrangements are independent from each other, the mother dies are prevented from being warped. Therefore, the lenses pressed by the forming dies at opposite ends are not deteriorated in optical performance and stable production is possible.

Since thermal deformation of the mother dies is suppressed, neither fitting error nor friction is caused, even if the clearance of the positioning member is reduced, when the upper and the lower dies approach each other. As a result, coaxiality of the upper and the lower forming dies is improved so that the eccentricity accuracy of the molded lens can further be improved.

Accordingly, this invention is also applicable to an objective lens of an optical pickup, which is required to have very strict eccentricity accuracy.

As described above, according to this invention, the heating coils for the movable die are selectively heated so that the movable die can be continuously heated in the supplying step of supplying the material and in the removing step of removing the molded product. Therefore, it is possible to shorten the time required to reach the desired molding temperature and to shorten the molding cycle time.

Although the present invention has been shown and described in conjunction with the preferred embodiment thereof, it will readily be understood by those skilled in the art that the present invention is not limited to the foregoing description but may be changed and modified in various other manners without departing from the spirit and scope of the present invention as set forth in the appended claims.

What is claimed is:

1. A press-molding apparatus comprising upper and lower dies which are faced with each other and at least one of which is movable as a movable die, and a pair of heating members as upper-die and lower-die heating means having heating coils-for induction-heating the upper and the lower dies, respectively, wherein:
the heating member for heating the movable die comprises a first heating coil for heating the movable die in a first position, a second heating coil for heating the movable die in a second position which is apart from the other die than said first position, and switching means for selectively supplying the first or the second heating coil with an electric current from a power supply.

2. The press-molding apparatus according to claim 1, wherein each of the upper-die and the lower-die heating means has an independent power supply.

3. The press-molding apparatus according to claim 2, wherein the independent power supplies of the upper-die and the lower-die heating means provide oscillation frequencies different from each other.

4. A method of producing an optical element by use of a press-molding apparatus, said apparatus comprising upper and lower dies which are faced with each other and at least one of which is movable as a movable die, and a pair of heating members as upper-die and lower-die heating means having heating coils for induction-heating the upper and the lower dies, respectively, said heating member for heating the movable die comprising a first heating coil for heating the movable die in a first position, a second heating coil for heating the movable die in a second position which is apart from the other die than said first position, and switching means for selectively supplying the first or the second heating coil with an electric current from a power supply;
said method comprising:
energizing the first heating coil when the movable die is in the first position; and
energizing the second heating coil when the movable die is in the second position.

5. The press-molding method according to claim 4, wherein the first heating coil for heating the movable die in the first position and the heating coil for heating the other die are energized at different frequencies.

6. The press-molding method according to claim 4, wherein the first heating coil for heating the movable die in the first position and the heating coil for heating the other die are energized in a time-division fashion.

7. The press-molding method according to claim 6, wherein one and the other of the upper and the lower dies faced with each other are a fixed die and a movable die, respectively, and the heating coil for heating the fixed die and the second heating coil for heating the movable die in the second position are simultaneously energized.

8. The method according to claim 4, further comprising:
heating upper and lower dies when the movable die is in the first position;
supplying a heated and softened material between the upper and the lower dies which are spaced apart so that the movable die is in the second position;
press-molding the material to the optical element with the upper and the lower dies; and
removing the optical element thus molded from between the upper and the lower dies when the upper and the lower dies are spaced apart so that the movable die is in the second position.
